(19) United States
(12) Patent Application Publication
(10) Pub. No.: US 2015/0006308 A1
(43) Pub. Date: Jan. 1, 2015

(54) IN-STORE COLLABORATIVE SHOPPING

(71) Applicant: ZIHENG LIN, Singapore (SG)

(72) Inventor: ZIHENG LIN, Singapore (SG)

(21) Appl. No.: 13/929,790

(22) Filed: Jun. 28, 2013

(51) Int. Cl. G06Q 30/06

(52) U.S. Cl. CPC G06Q 30/0605; G06Q 30/0633
USPC 705/26.2

(57) ABSTRACT

In an embodiment, a primary user initiates a collaborative session in a shopping application executing in a mobile device of the primary user. Primary user can select secondary users and invite them to join the collaborative shopping in-store. Primary user can select a specific store, retrieve and view items in a catalog associated with the store. Primary user and the secondary users in the collaborative session, can collaboratively select items from the catalog and compile a collaborative shopping list. The primary and secondary users can add the items from the compiled collaborative shopping list to a shopping cart. The location of the primary and secondary users and the location of the selected and added items are displayed in a store navigator user interface in the collaborative session. The primary or secondary user can choose to end the collaborative shopping, by initiating a self-checkout to close the collaborative session.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an overview of an exemplary environment for in-store collaborative shopping, according to an embodiment.

FIG. 2 is a block diagram illustrating an overview of functionalities in a shopping application, according to one embodiment.

FIG. 3 illustrates a sequence of user interfaces for inviting users to a collaborative session, according to one embodiment.

FIG. 4 illustrates a sequence of user interfaces for compiling collaborative shopping list and assigning items to users, according to one embodiment.

FIG. 5 illustrates a sequence of user interfaces for adding the items assigned to users to the shopping cart, according to one embodiment.

FIG. 6 illustrates a sequence of user interfaces for deleting items in the shopping cart, according to one embodiment.

FIG. 7 illustrates a sequence of user interfaces for notifying an item change request in the shopping cart, according to one embodiment.

FIG. 8 illustrates a store navigator user interface for displaying the location of the users and the items added by the users, according to one embodiment.

FIG. 9 illustrates a group chatting user interface displaying chat window, according to one embodiment.

FIG. 10 illustrates a flow diagram of a method of in-store collaborative shopping, according to one embodiment.

FIG. 11 is a block diagram of an exemplary computer system according to one embodiment.

### DETAILED DESCRIPTION

Embodiments of techniques for in-store collaborative shopping are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In a large retail store or outlet, various categories of items or products are organized in various floors and sections of the store. When users shop in person in such retail store, it is referred to as in-store shopping. In the in-store shopping by a group of related users such as family or friends, either the group of related users shop together using a single shopping list, or individual users carry a subset of the shopping list and shop in the store. In the scenario where the group of related users shop together using a single shopping list, the inefficiency is because the group needs to move together and purchase items one after the other in a time consuming manner.

In the scenario where the individual users carry the subset of the shopping list and shop the store, though its time efficient, the challenge appears to be collaboration among the users in the group, especially when items are available at various floors of the store. For example, if one user finds an ‘Item X’ of ‘Brand A’ to be unavailable and alternatively finds ‘Item X’ in a different brand ‘Brand B’, it is challenging to communicate this information to the second user immediately and get an opinion for purchasing the same. Furthermore, even when a user has only few items to purchase, the user is required to wait in long queue to checkout after shopping. Self-service checkout kiosks also require a considerable waiting time by the users. In such scenarios noted above, the manual approach of collaboration is inefficient, not scalable, does not provide real time synchronization among the group of related users and does not eliminate the user waiting time.

Users require collaboration in real-time while shopping in a store. They should be able to invite other users for shopping, compile a collaborative shopping list along with the invited users, receive updates from other users as they make purchase, discuss and communicate with other users while shopping, and checkout using a mobile application without waiting in queue. Collaborating shopping information in real-time has numerous advantages such as manageability, effective communication, synchronization of data among the group of users, integration with other products such as retailer application, mobile checkout at the store, and the like.

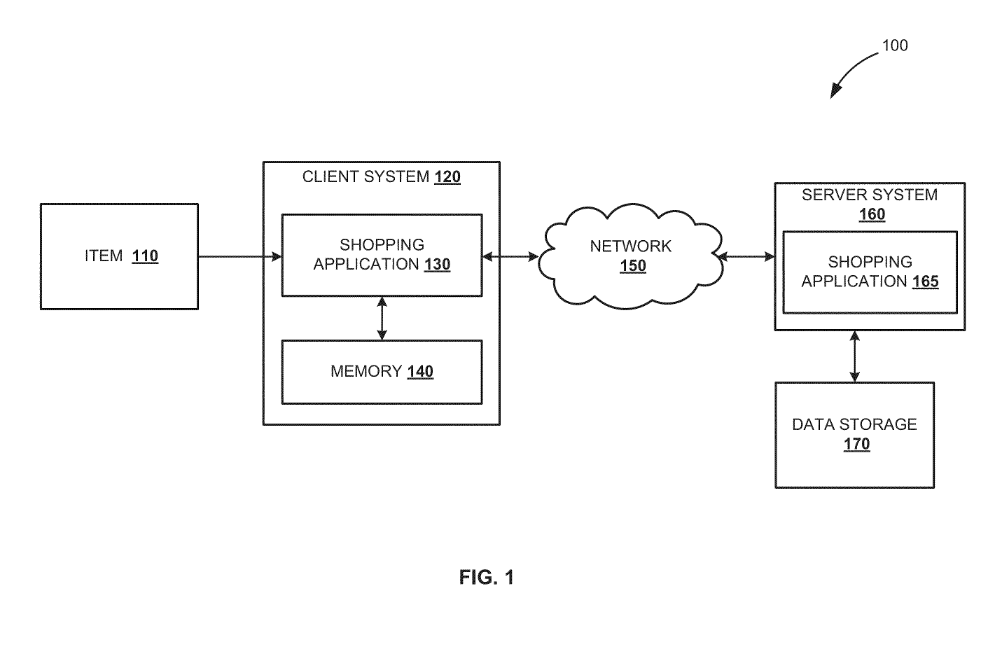

FIG. 1 is a block diagram illustrating an exemplary environment for in-store collaborative shopping, according to an embodiment. The exemplary environment 100 is shown containing client system 120, shopping application 130, memory 140, network 150, server system 160, item 110 and data storage 170. Merely for illustration, only a representative number and type of systems is shown in FIG. 1. Often, environments contain more systems (e.g., more server systems), both in number and type, depending on the purpose for which an environment is designed. Each system/device of FIG. 1 is described below in further detail.

Network 150 provides connectivity between server system 160 and client system 120. Network 150 may be implemented using protocols such as Transmission Control Protocol (TCP) and/or Internet Protocol (IP), well known in the relevant art. In general, in TCP/IP environments, a TCP/IP packet is used as a basic unit of transport, with the source address being set to the TCP/IP address assigned to the source system from which the packet originates, and the destination address set to the TCP/IP address of the target system to which the packet is to be eventually delivered.

Server system 160 represents a server, such as a web application server, executing software applications, for example, retail enterprise shopping application such as shopping application 165 capable of performing tasks requested by clients/users. In general, server system 160 receives requests for performing tasks from users using client system 120, performs the requested tasks on data maintained internally or on external data, for example, data stored in data storage 170, and then sends the result of performance of the tasks to the requesting client system 120.

The client system 120 can be a computing device such as a mobile phone or a tablet computer used by end users to generate requests directed to shopping application 130, executing in the client system 120. The requests may be generated using appropriate user interfaces. In general, an end-user requests the shopping application 130 for performing tasks and receives corresponding responses containing the results. The shopping application 130 also requests the server system 160 for performing specific tasks and receives corresponding response from the server system 160. Requests may be sent in the form of TCP/IP packets directed to the desired server system 160, with the TCP/IP packets including data identifying the tasks in their payload portion.

The client system 120 includes a shopping application 130. The shopping application 130 executes in the client system 120, and provides a user interface, for example, based on display and inputs, such as touch, keypad and pointer device. User interacts with the user interface provided by the shopping application 130 executing in the client system 120 and thus with the retail enterprise shopping application, i.e. shopping application 165 executing in the server system 160. Information associated with the item 110 is received by the shopping application 130 for processing. In one embodiment, the shopping application 130 can be application software comprising a set of instructions, published on a web or application server, which can be downloaded and installed on the client system 120. For example, shopping application 130 can be a mobile application available for download in an application store, provided by a vendor or any service provider. In another embodiment, the shopping application 165 executing on a server system, can be accessed over a network 150 from the client system 120, for example as an on-demand software such as, software as a service (SaaS).

The client system 120 also includes a memory 140. The memory 140 stores the data, fetched from the server system 160, to enable the user to perform operations on the shopping application 130. The result of user operation is stored in the memory 140 and subsequently synchronized with the data storage 170 in real-time. The memory 140 may be internal to the client system 120, such as flash drive. Data storage 170 represents a non-volatile storage, facilitating storage and retrieval of data by retail enterprise application, for example, shopping application 130, executing in server system 160.

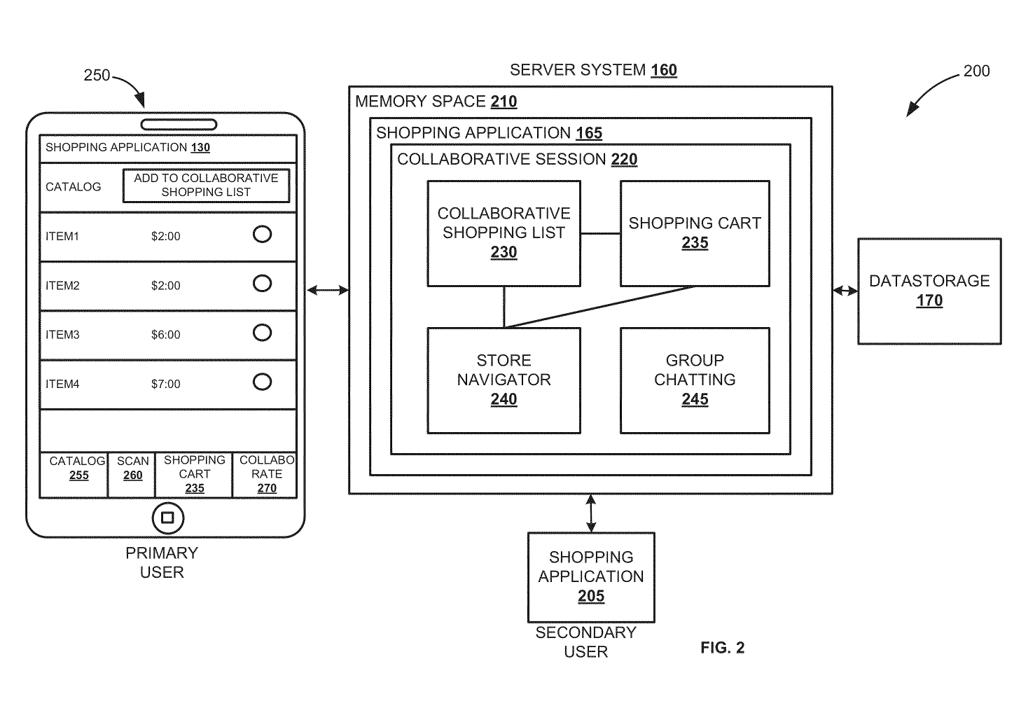

FIG. 2 is a block diagram illustrating an overview of functionalities available in a shopping application, according to one embodiment. The block diagram 200 is shown containing shopping application 130 executing in the mobile device of a ‘primary user’, a shopping application 205 executing (not shown) in the mobile device of a ‘secondary user’, server system 160 comprising a memory space 210 executing a collaborative session 220 in the shopping application 165, and the data storage 170. ‘Primary user’ is referred to as a user initiating the collaborative session and the other users invited by the ‘primary user’ to join the collaborative session as referred to as ‘secondary users’. Shopping application 130 is a mobile application that is downloaded from an application store, and installed on the mobile device 250 of the ‘primary user’. The shopping application 130 executing in the mobile devices 250 of the ‘primary user’ and the ‘secondary user’, enables collaborative in-store shopping based on the functionalities in the shopping application 165. For every functionality in the shopping application 165, corresponding functional options or links are provided in the shopping application 130 executing in the mobile device 250 of the ‘Primary user’. ‘Primary user’ interacts with the user interface of the shopping application 130 executing in the client system 120 by various interactive operations such as touch, tap, click, press, hover, etc., and thus interacts with the shopping application 165, executing in the server system 160. Both ‘primary user’ and the ‘secondary user’ have similar functionalities in the shopping application executing in their respective mobile devices.

In one embodiment, the ‘primary user’ logs in to the shopping application 130 executing in the mobile device 250, by providing appropriate login credentials, and initiates a collaborative session 220 in the shopping application 165 executing in the server system 160. In the shopping application 130, the ‘primary user’ can collaborate with a group of ‘secondary users’ using collaborate 270 functionality provided in the shopping application 130. When the ‘primary user’ clicks or taps on the collaborate 270 functionality, a list of ‘secondary users’ available in a store are displayed in the shopping application 130.

‘Primary user’ can select ‘secondary users’ and invite them to join the collaborative shopping. ‘Secondary users’, having accepted the invitation, join the collaborative session 220 using their respective mobile devices. ‘Primary user’ can select the store, retrieve a catalog associated with the store and view the items in the catalog using the catalog 255 functionality. Catalogs, retrieved and displayed in the mobile device 250, is referred to as an in-store shopping catalogs. ‘Primary user’ and the ‘secondary users’ in the collaborative session 220 can collaboratively select items from the displayed catalog, and compile a collaborative shopping list 230. This collaborative shopping list 230 compiled by the ‘primary user’ and the ‘secondary users’, is synchronized with the shopping application 165 executing in the server system 160 in real-time. Thus ‘primary user’ and ‘secondary users’ are able to view the collaborative shopping list 230 simultaneously in real-time.

Based on the compiled collaborative shopping list 230, the ‘primary user’ and the ‘secondary users’ start adding the items from the collaborative shopping list 230 to a shopping cart 235, e.g., by scanning barcode of the items using scan 260 functionality in the shopping application 130. The barcode is merely exemplary, various types of machine readable representations such as QR code, SPARQCode, maxi code, etc., can be used. The scanning can be performed using a camera in the mobile device 250 of the ‘primary user’. The location of the ‘primary user’ and the secondary users are displayed using store navigator 240 functionality in the shopping application 130. The ‘primary user’ and ‘secondary users’ can collaborate with each other using the group chatting 245 functionality in the shopping application 165. To enable such group chatting, group chatting functionality is provided (not shown) in the shopping application 130 executing in the mobile device 250 of the ‘primary user’.

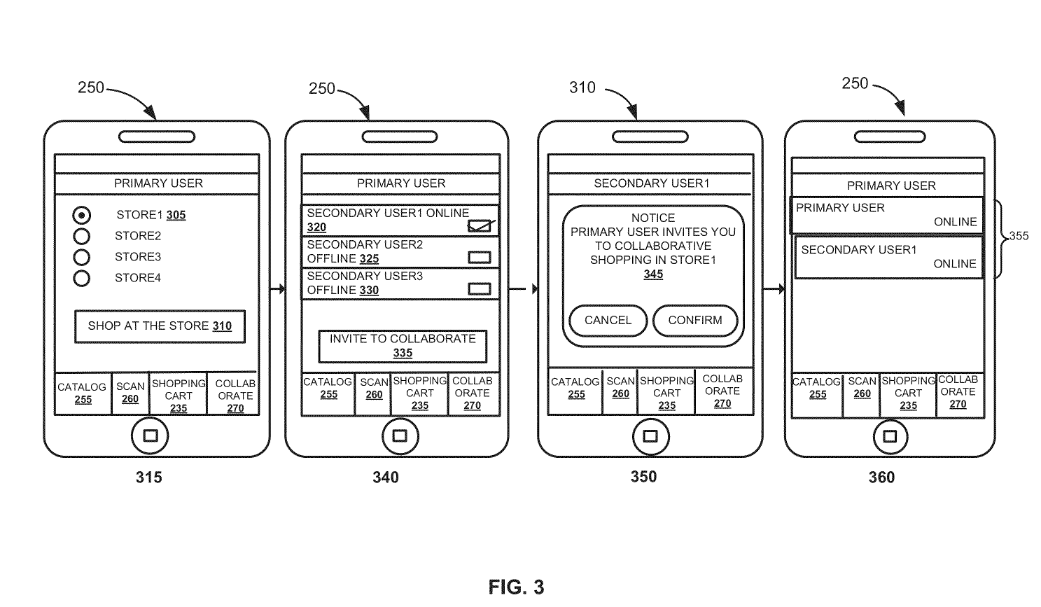

The example embodiments illustrated below using FIG. 3 to FIG. 9, describe in detail the functionalities in the shopping application 130 noted above. The functionalities are illustrated in view of the collaborative session 220 of FIG. 2 initiated by the ‘primary user’. FIG. 3 illustrates a sequence of user interfaces for inviting users to a collaborative session, according to one embodiment. For example, in the collaborative session, a list of stores is provided in the user interface of the shopping application rendered in the mobile device 250 of the ‘primary user’. ‘Primary user’ selects ‘store 1’ 305 and clicks on ‘shop at the store’ 310, to initiate in-store collaborative shopping as shown in 315. The shopping application 130 provides users with the option to initiate the collaborative session, using the collaborate 270 functionality provided in the mobile device 250 of the ‘primary user’. Once the collaborative session is established, ‘primary user’ is provided with a list of secondary users along with the status associated with each ‘secondary user’ as shown in 340. The secondary users are displayed along with the status associated with them, such as ‘online’ if the ‘secondary user’ is currently online and available for collaborative shopping, ‘offline’ if the ‘secondary user’ is currently offline and not available for collaborative shopping. Accordingly, ‘secondary user1’ online 320, ‘secondary user2’ offline 325 and ‘secondary user3’ offline 330 is displayed as shown in 340.

‘Primary user’ can select the online secondary users and invite them for collaborative shopping in the collaborative session. ‘Primary user’ selects the ‘secondary user1’ online 320 and invites for collaborative shopping by clicking on ‘invite to collaborate’ 335. The ‘secondary user1’ receives a notice as, ‘Primary user invites you to collaborative shopping in store1’ 345 in the user interface of the shopping application 130 in the mobile device 310 of the ‘secondary user1’ as shown in 350. ‘Secondary user1’ clicks on confirm to accept the collaborative shopping invitation from the ‘primary user’. Upon invitation acceptance by the ‘secondary user1’, both the ‘primary user’ and the ‘secondary user1’ can view the list of users 355 currently available in the collaborative session of the shopping application 130 as shown in 360.

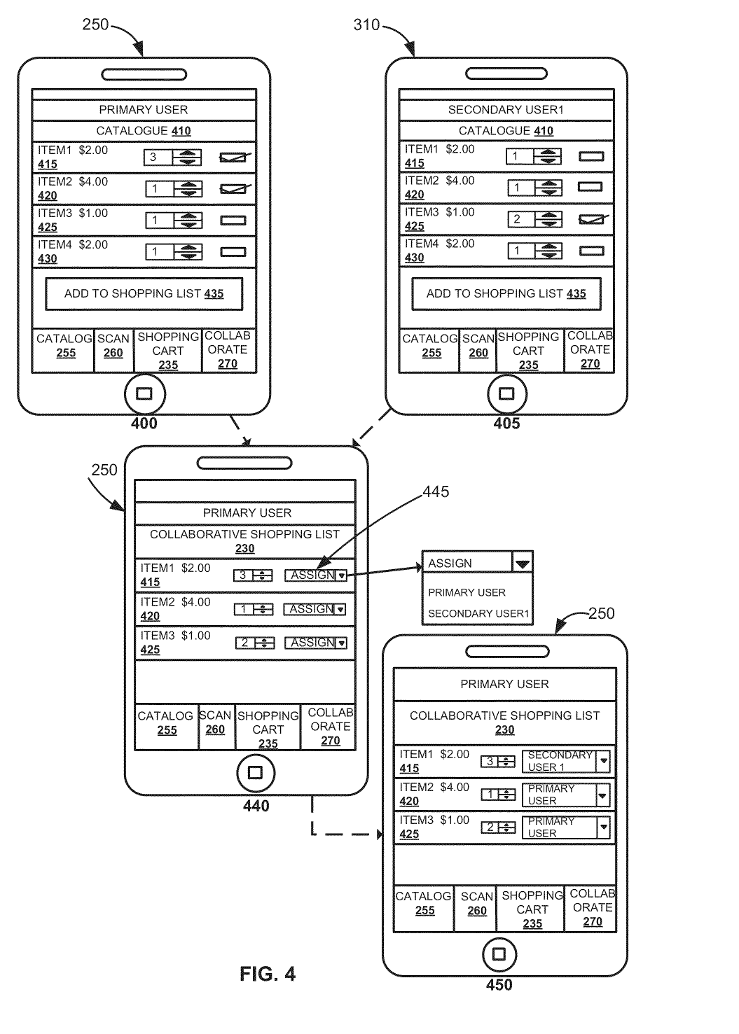

The list of users 355 currently available in the collaborative session can collaboratively shop in ‘store 1’ 305. FIG. 4 illustrates a sequence of user interfaces for compiling collaborative shopping list and assigning items to users, according to one embodiment. When user clicks on ‘catalog’ 255 functionality, catalog 410 is retrieved from the ‘store 1’ 305, and is displayed in the user interface displayed in the mobile device 250 of the ‘primary user’ and the mobile device 310 of the ‘secondary user1’. Initially when the collaborative session is initiated, the list of users 355 available in the collaborative session have both read and write access to the collaborative shopping list 230. ‘Primary user’ selects ‘item1’ 415 and specifies the quantity as 3, selects ‘item2’ 420 and specifies the quantity as 1 and clicks on ‘Add to shopping list’ 435, to add the selected items from the catalog 410 to the collaborative shopping list 230 as shown in 400. ‘Secondary user1’ selects ‘item3’ 425 and specifies the quantity as 2 and clicks on ‘Add to shopping list’ 435 to add the selected items to the collaborative shopping list 230 as shown in 405. The collaborative shopping list 230, displays all the three items added by both the ‘primary user’ and the ‘secondary user1’ in the mobile device 250 of the ‘primary user’ as shown in 440 and in the mobile device 310 of the ‘secondary user1’ (not shown) simultaneously in real-time. In one embodiment, the ‘primary user’ has a pre-compiled shopping list comprising items to be purchased in the shopping application. The ‘primary user’ can choose to add the pre-compiled shopping list to the collaborative shopping list 230.

In one embodiment, the items in the collaborative shopping list 230 can be assigned to individual users, so that the individual users can add the assigned items to a shopping cart 235. ‘Item1’ 415 can be assigned to any individual user using the ‘assign’ 445 drop down provided along with the items in the collaborative shopping list 230. When the ‘assign’ 445 drop down is clicked, the list of users 355 of FIG. 3 currently available in the collaborative session are displayed such as the ‘primary user’ and the ‘secondary user1’. ‘Item1’ 415 is assigned to the ‘secondary user1’, ‘item2’ 420 is assigned to the ‘primary user’ and ‘item3’ 425 is assigned to the ‘primary user’. This assignment is visible in the mobile device 250 of the primary user and the mobile device of the ‘secondary user1’ 310 in real-time. Items assigned to the users are displayed in the user interface of the mobile device 250 of the ‘primary user’ as shown in 450. In one embodiment, either the ‘primary user’ or the ‘secondary user1’ can assign items to any other users in the collaborative session.

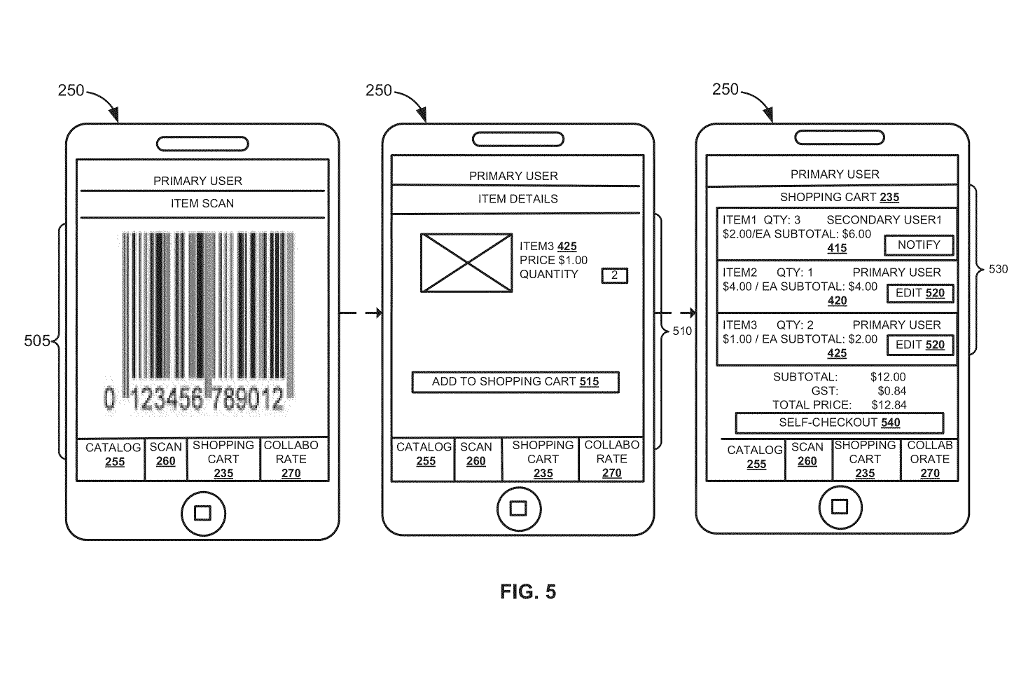

FIG. 5 illustrates a sequence of user interfaces for adding the items assigned to users to the shopping cart, according to one embodiment. Since ‘item3’ 425 is assigned to the ‘primary user’, the ‘primary user’ can add ‘item3’ 425 to the shopping cart 235, by clicking on the scan 260 functionality. This opens a window 505 to capture a barcode associated with the ‘item3’ 425, and display the information associated with ‘item3’ 425 in a user interface 510. In the user interface 510, the information associated with ‘item3’ 425, such as price ‘$1.00’ and quantity as ‘1’ is displayed. ‘Primary user’ inputs the quantity as ‘2’ and clicks on ‘add to shopping cart’ 515 to add ‘item3’ 425 to the shopping cart 235. Similarly, the ‘primary user’ adds ‘item 2’ 420 by specifying the quantity as ‘1’ and the ‘secondary user1’ adds ‘item 1’ 415 by specifying the quantity as ‘3’. Thus, the three items added to the shopping cart 235 are displayed in 530. Along with the display of each individual item in the shopping cart 235, an option ‘edit’ 520 to edit the items is also provided. Using the ‘edit’ 520 option, users can edit the information associated with the items as required. Based on the number of items and the quantity of the items added to the shopping cart 235, a total price is automatically computed and displayed to the ‘primary user’. In one embodiment, the ‘primary user’ can choose to end the collaborative shopping, by initiating a self-checkout by clicking on ‘self-checkout’ 540 functionality to close the collaborative session 220, executing in the shopping application 165.

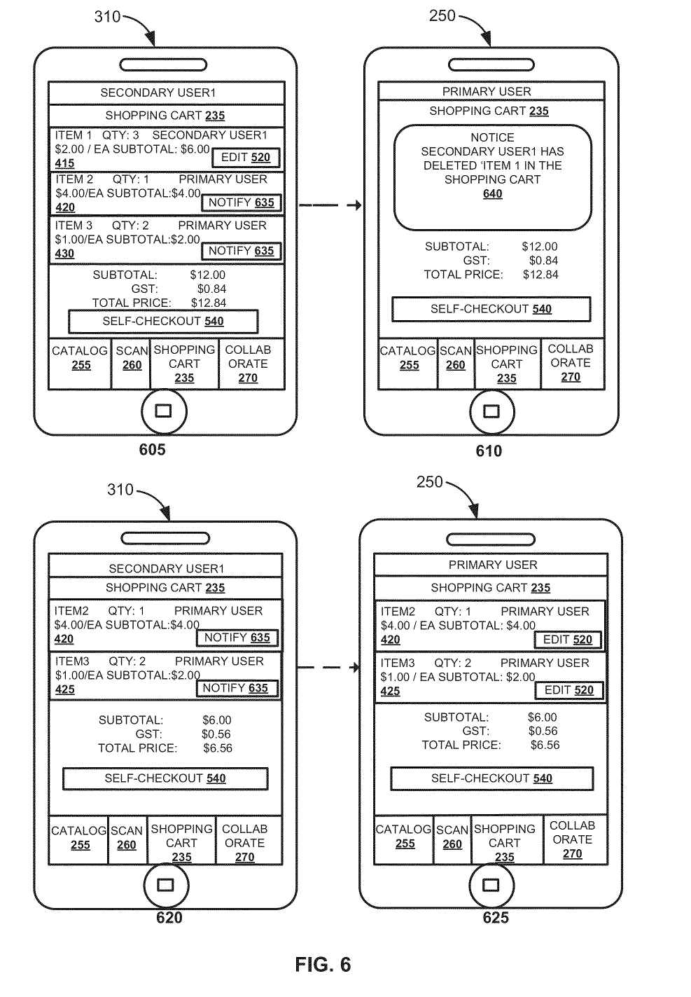

FIG. 6 illustrates a sequence of user interfaces for deleting items in the shopping cart, according to one embodiment. In 605. ‘secondary user1’ edits and deletes the ‘item1’ 415 in the mobile device 310. Since ‘item1’ 415 was assigned to ‘secondary user1’ and ‘secondary user1’ had added ‘item’ 415, only ‘secondary user1’ has the access to ‘edit’ 520 ‘item’ 415. Upon deletion of ‘item1’ 415 by the ‘secondary user1’, a notification “secondary user1 has deleted ‘item1’ in the shopping cart” 640 is sent to the mobile device 250 of the ‘primary user’ as shown in 610. After deletion of ‘item1’ 415, the updated shopping cart 235 is displayed in the mobile device 310 and the mobile device 250 of the ‘secondary user1’ and the ‘primary user’ in real-time as shown in 620 and 625, respectively. The total price is correspondingly recomputed and displayed in the mobile device 250 and the mobile device 310.

‘Primary user’ has read access to the items added by the ‘secondary user1’ and write access to the items added by the ‘primary user’. For example, since ‘item2’ was added by the ‘primary user’, ‘primary user’ has write access to ‘item2’ and accordingly ‘edit’ 520 option is provided along with ‘item2’ for the primary user as shown in 625. Since ‘item2’ was added by the ‘primary user’, ‘secondary user 1’ has only read access to ‘item2’, and accordingly ‘secondary user1’ is provided with ‘notify’ 635 option to notify the ‘primary user’ in case ‘item2’ needs to be edited as shown in 605 and 620.

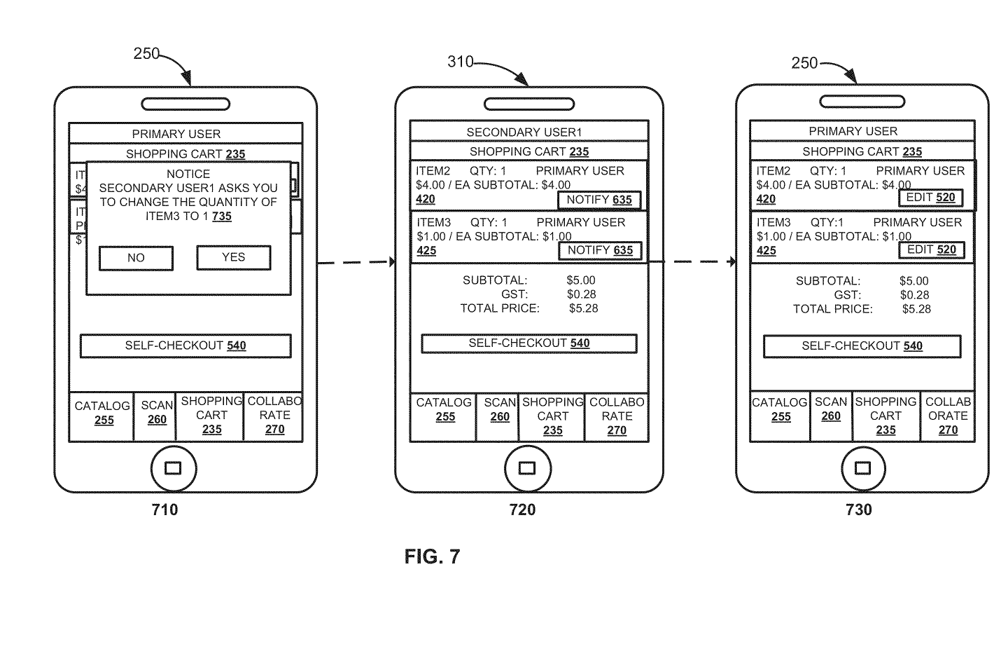

FIG. 7 illustrates a sequence of user interfaces for notifying an item change request in the shopping cart, according to one embodiment. ‘Secondary user1’ intends to change the quantity of ‘item3’ 425 from ‘2’ to ‘1’. Since ‘secondary user1’ does not have a write access to ‘item3’ 425 added by the ‘primary user’, ‘secondary user 1’ sends an item change request to the ‘primary user’ to request for change of quantity of ‘item3’. This change request appears as a notice ‘secondary user1’ asks you to change the quantity of ‘item3’ to ‘1’ 735, in the user interface of the mobile device 250 of the primary user as shown in 710. When ‘primary user’ changes the quantity of ‘item3’ to ‘1’, the change is visible in the shopping cart 235 displayed in the mobile device 250 and the mobile device 310 of the primary and secondary users as shown in 720 and 730, respectively.

Either the ‘primary user’ or the ‘secondary user1’ can initiate self-checkout by clicking on ‘self-checkout’ 540 to close the collaborative session, and initiate a mobile payment process. Thus the collaborative session will be closed for both the ‘primary user’ and the ‘secondary user1’. For example, if the ‘primary user’ has initiated self-checkout by clicking on ‘self-checkout’ 540, the ‘secondary user1’ will not be able to add or edit any items since the collaborative session is closed. When the mobile payment process is initiated, appropriate payment gateway service is invoked, and the ‘primary user’ can provide payment related information such as credit card number, expiry date, and the like, to proceed with the payment. In one embodiment, the initiation of self-checkout is referred to as a mobile self-checkout, where the ‘primary user’ can initiate the ‘self-checkout’ 540 in the shopping application 130 executing in the mobile device 250 from any location in the store. Therefore, the ‘primary user’ is not required to wait in queue at the checkout counters or checkout kiosks.

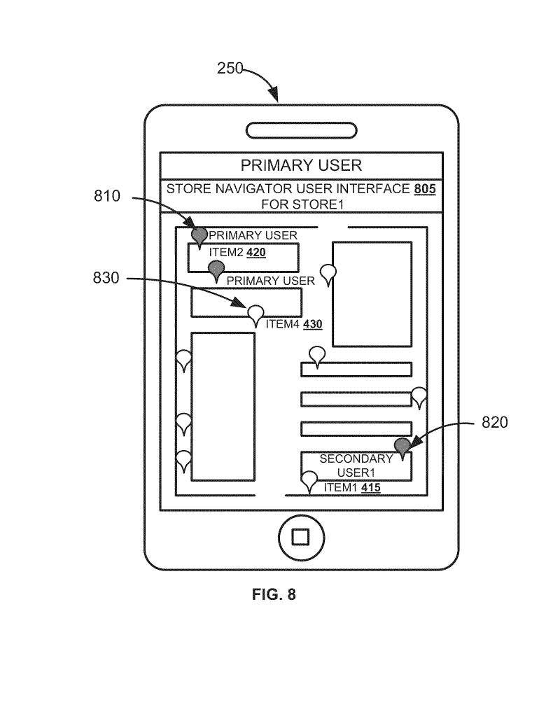

FIG. 8 illustrates a store navigator user interface for displaying the current location of the users and the items added by the users, according to one embodiment. In the store navigator user interface 805 for ‘store1’, current location of ‘item2’ 420 along with the name of ‘primary user’ is displayed as shown in 810. Current location of ‘item1’ 415 along with the name of ‘secondary user1’ is displayed as shown in 820. In one embodiment, location related information gathered from the ‘primary user’ and the ‘secondary user1’ is sent to the collaborative session 220 in the shopping application 165 executing in the server system 160 of FIG. 1 to compute the current location of the users. For example, location related information of the ‘primary user’ and ‘secondary user1’ is received using Wi-Fi® sniffers installed in the ‘store1’ 405. Wi-Fi® sniffers are hardware devices that are capable of receiving radio signals from the mobile devices 250 and 310 of the ‘primary user’ and the ‘secondary user1’, respectively.

Wi-Fi® sniffers send received information such as received signal strength indication (RSSI), MAC address of the mobile and timestamp to the server system 160 of FIG. 1. Based on the received location related information, the server system 160 computes the current location of the ‘primary user’ and the ‘secondary user1’ using Wi-Fi® triangulation. Wi-Fi™ triangulation is accomplished in two phases, namely calibration and positioning. The first phase is to collect RSSI to build a radio map. During the second phase, RSSI from the mobile devices of the ‘primary user’ and the ‘secondary user1’ are received and compared with the built radio map, and a calculation is performed to locate the current position of the mobile devices. The computed current location of the ‘primary user’ and the ‘secondary user1’ is sent to the store navigator user interface 805 in the collaborative session, executing in the mobile device 250 of the ‘primary user’ and the mobile device 310 of the ‘secondary user1’ respectively for display.

In one embodiment, a floor layout of the store is displayed in the store navigator user interface 805 with the current location of the items in the collaborative shopping list 230 highlighted. Users are able to locate items using the floor layout and proceed with the collaborative shopping. Users are able to view in the floor layout of the store navigator user interface 805 the current location of the items added in the shopping cart 235, and the current location of the items in the collaborative shopping list 230 that are not yet added in the shopping cart 235. Users can also search the current location of any item using the floor layout of the store navigator user interface 805. In one embodiment, layout of the store and location related information associated with the items is stored in a store map. Whenever new items are added in the store, a current location corresponding to the new items and associated quantity of the new items are added in the store map. Similarly, whenever items are removed from the shelves, or moved between shelves, the associated quantity and the location of the items are updated in the store map. Based on the location related information stored in the store map, the floor layout of the store navigator user interface 805 displays the current location of the items. In one embodiment, whenever items are removed from the shelves, the items and the quantity associated with the items are automatically updated in the store map based on self-checkout by the user.

In one embodiment, current location of the items added by the users in the shopping cart 235 are displayed in a first color and the current location of the items in the collaborative shopping list 230 yet to be added by the users in the shopping cart 235 are displayed in a second color. For example, current location of ‘item2’ 420 added by the ‘primary user’ in shopping cart 235 is displayed in grey colored icon as shown in 810, and current location of ‘item 4’ 430 in the collaborative shopping list 230 yet to be added by the users is displayed in white colored icon as shown in 830.

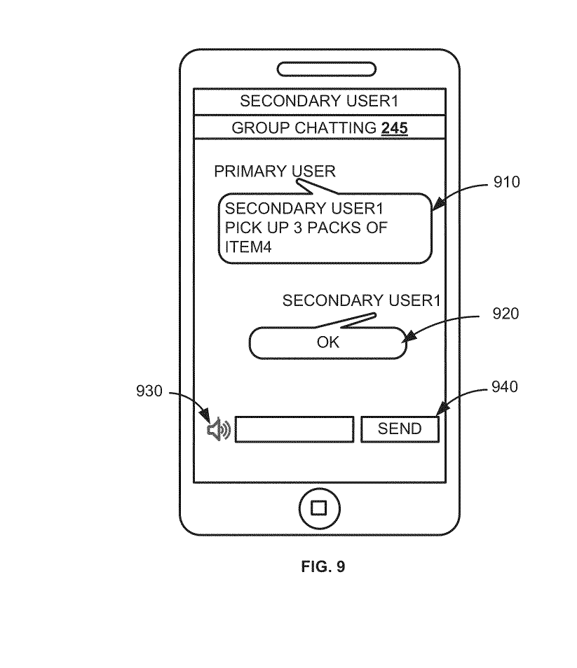

FIG. 9 illustrates group chatting user interface displaying chat window, according to one embodiment. In group chatting 245, the ‘primary user’ and the ‘secondary user1’ can communicate with each other using text chat and voice chat features in the collaborative session. ‘Primary user’ can send a text chat message ‘secondary user1’ pick up 3 packs of item4″ 910 to the ‘secondary user1’. The ‘secondary user1’ receives the text chat message 910 and correspondingly replies with the text chat message “ok” 920. This group chatting 245 functionality is available for all the users in the collaborative session. In one embodiment, chat can be performed over voice signals. ‘Primary user’ can send voice chat message by enabling the microphone 930 feature, and send the voice chat message to the ‘secondary user1’ using ‘send’ 940 option. The ‘primary user’ and the ‘secondary user1’ are thus able to communicate and exchange message in real-time using the group chatting 245 functionality in the collaborative session.

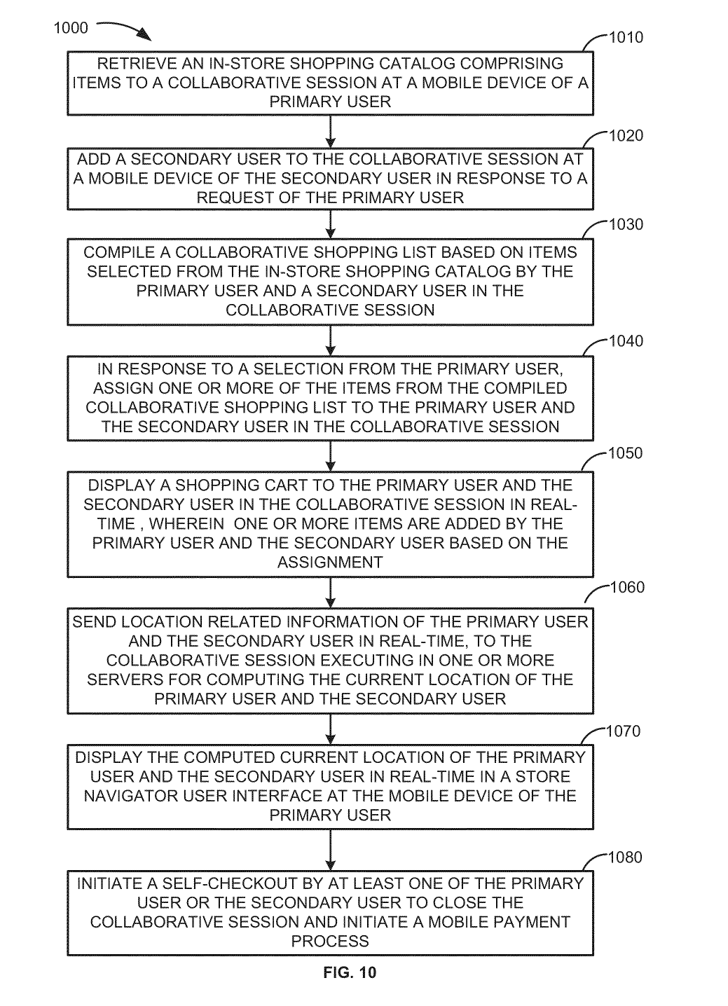

FIG. 10 illustrates a flow diagram of a process 1000 of in-store collaborative shopping, according to one embodiment. At 1010, an in-store shopping catalog comprising items is received at a collaborative session initiated from a mobile device of a ‘primary user’. At 1020, add a ‘secondary user’ to the collaborative session at a mobile device of the secondary user in response to a request of the primary user. At 1030, a collaborative shopping list is compiled based on the items selected from the in-store shopping catalog by the ‘primary user’ and the ‘secondary user’ in the collaborative session. At 1040, ‘primary user’ assigns one or more of the items from the compiled collaborative shopping list to the ‘primary user’ and the ‘secondary user’ in the collaborative session. The assignment may be in response to a clicking by the ‘primary user’ on an ‘assign’ drop down and selecting the appropriate user. At 1050, the ‘primary user’ and the ‘secondary user’ can add one or more of the items from the collaborative shopping list to a shopping cart, based on the assignment. Adding the one or more items may be performed by scanning a barcode associated with the one or more items. The shopping cart is displayed to both the primary user and the secondary user in real-time.

At 1060, location related information of the ‘primary user’ and the ‘secondary user’ is sent to the collaborative session in the shopping application executing in one or more servers in real-time. The one or more servers compute current location of the ‘primary user’ and the ‘secondary user’ based on the received location related information associated with the ‘primary user’ and the ‘secondary user’. At 1070, the computed current location of the ‘primary user’ and the ‘secondary user’ is displayed in real-time in a store navigator user interface in the mobile device of the ‘primary user’. At 1080, a self-checkout is initiated by at least one of the ‘primary user’ or the ‘secondary user’ to close the collaborative session and initiate a mobile payment process. Based on either of the users initiating the self-checkout, the collaborative session is closed and the users cannot add items to the shopping cart. In one embodiment, a user can choose to initiate a single shopping session in the shopping application executing in a mobile device of the user.

The various embodiments described above have a number of advantages. For example, users in a group can collaborate in real-time while shopping in the store. The users in the group are able to view the items added by the other users in real-time. By establishing a collaborative session in the shopping application, managing collaborative shopping by even a large group of users proves efficient. Collaborating change requests among users takes place in real-time and is less time consuming. In case the user has to pick a few items, the user can initiate a self-checkout using the mobile device at any location and proceed with the payment. Thus user can avoid waiting in queue to check out and make payment. Using self-checkout, user's shopping time is drastically reduced. Client application is portable and flexible to be used in any remote location and in any client device, thus improving efficiency, performance and in-store shopping experience of users.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape: optical media such as CD-ROMs, DVDs and holographic devices: magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

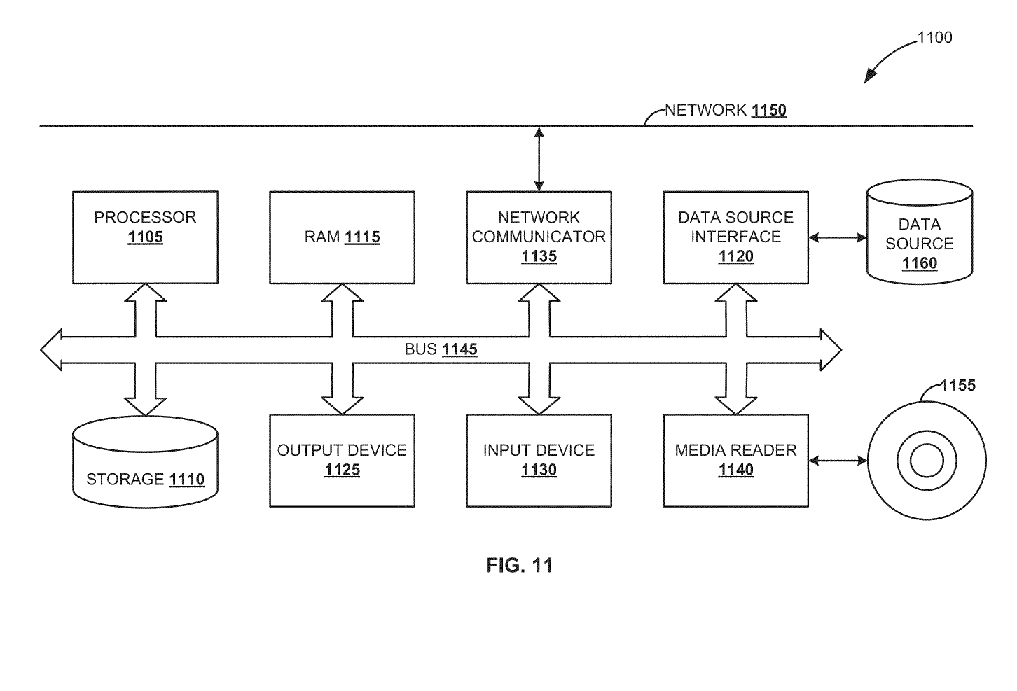

FIG. 11 is a block diagram of an exemplary computer system 1100. The computer system 1100 includes a processor 1105 that executes software instructions or code stored on a computer readable storage medium 1155 to perform the above-illustrated methods. The computer system 1100 includes a media reader 1140 to read the instructions from the computer readable storage medium 1155 and store the instructions in storage 1110 or in random access memory (RAM) 1115. The storage 1110 provides a large space for keeping static data where at least some instructions could be stored for later execution. The stored instructions may be further compiled to generate other representations of the instructions and dynamically stored in the RAM 1115. The processor 1105 reads instructions from the RAM 1115 and performs actions as instructed. According to one embodiment, the computer system 1100 further includes an output device 1125 (e.g., a display) to provide at least some of the results of the execution as output including, but not limited to, visual information to users and an input device 1 130 to provide a user or another device with means for entering data and/or otherwise interact with the computer system 1100. Each of these output devices 1125 and input devices 1130 could be joined by one or more additional peripherals to further expand the capabilities of the computer system 1100. A network communicator 1135 may be provided to connect the computer system 1100 to a network 1150 and in turn to other devices connected to the network 1150 including other clients, servers, data stores, and interfaces, for instance. The modules of the computer system 1100 are interconnected via a bus 1145. Computer system 1100 includes a data source interface 1120 to access data source 1160. The data source 1160 can be accessed via one or more abstraction layers implemented in hardware or software. For example, the data source 1160 may be accessed by network 1150. In some embodiments the data source 1160 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

The claims are as follows:

1. An article of manufacture including a non-transitory computer readable storage medium to tangibly store instructions, which when executed by a computer, cause the computer to:
retrieve an in-store shopping catalog comprising items to a collaborative session at a mobile device of a primary user,
add a secondary user to the collaborative session at a mobile device of the secondary user in response to a request of the primary user,
compile a collaborative shopping list based on items selected from the in-store shopping catalog by the primary user and the secondary user in the collaborative session;
in response to a selection from the primary user, assign one or more of the items from the compiled collaborative shopping list to the primary user or to the secondary user in the collaborative session;
display a shopping cart to the primary user and the secondary user in the collaborative session in real-time, wherein the one or more items are added by the primary user and the secondary user based on the assignment; and
initiate a self-checkout by at least one of the primary user or the secondary user to close the collaborative session and initiate a mobile payment process.

2. The article of manufacture of claim 1, further comprising instructions which when executed by the computer further causes the computer to:
display the assigned one or more items to the primary user and the secondary user in the collaborative session in real-time;
receive scanned input of a barcode and a quantity associated with the one or more items assigned to the secondary user in the collaborative session; and
add the scanned input to the shopping cart displayed to the primary user and the secondary user in the collaborative session.

3. The article of manufacture of claim 2, further comprising instructions which when executed by the computer further causes the computer to:
receive an item change from the primary user to a secondary user in the collaborative session, wherein the change request comprises at least one of a request to add a new item, and a request to delete one or more of the assigned item.

4. The article of manufacture of claim 3, further comprising instructions which when executed by the computer further causes the computer to:
receive an item change request to modify one or more of the assigned items from the primary user to a secondary user in the collaborative session, wherein the primary user is restricted write access on the one or more items added by the secondary user to the shopping cart; and
display a notice at the mobile device of the secondary user in response to the received item change request.

5. The article of manufacture of claim 1, further comprising instructions which when executed by the computer cause the computer to:
receive a selection of the secondary user displayed in the collaborative session and transmit an invitation to the selected secondary user, and
receive invitation acceptance from the secondary user and add the secondary user to the collaborative session in the shopping application, wherein the collaborative session further comprises a group chatting user interface where the primary user and the secondary user collaborate via text or voice messaging.

6. The article of manufacture of claim 1, further comprising instructions which when executed by the computer further causes the computer to:
send location related information of the primary user and the secondary user in real-time, to the collaborative session executing in one or more servers for computing the current location of the primary user and the secondary user,
display the computed current location of the primary user and the secondary user in real-time in a store navigator user interface in the mobile device of the primary user; and
display current location of the secondary user along with the one or more items added by the secondary user in the store navigator user interface in the mobile device of the primary user.

7. The article of manufacture of claim 6, further comprising instructions which when executed by the computer further causes the computer to:
display current locations of the one or more items added in the shopping cart in a first color, and current locations of the one or more items that are in the collaborative shopping list and yet to be added in the shopping cart in a second color in the store navigator user interface.

8. A computer implemented method for in-store collaborative shopping, the method comprising:
retrieving an in-store shopping catalog comprising items to a collaborative session at a mobile device of a primary user;
add a secondary user to the collaborative session at a mobile device of the secondary user in response to a request of the primary user,
compiling a collaborative shopping list based on items selected from the in-store shopping catalog by the primary user and a secondary user in the collaborative session;
in response to a selection from the primary user, assigning one or more of the items from the compiled collaborative shopping list to the primary user and the secondary user in the collaborative session;
displaying a shopping cart to the primary user and the secondary user in the collaborative session in real-time, wherein one or more items are added by the primary user and the secondary user based on the assignment; and
initiating a self-checkout by at least one of the primary user or the secondary user to close the collaborative session and initiate a mobile payment process.

9. The method of claim 8, further comprising:
displaying the assigned one or more items to the primary user and the secondary user in the collaborative session in real-time;
receiving scanned input of a barcode and a quantity associated with the one or more items assigned to the secondary user in the collaborative session; and
adding the scanned input to the shopping cart displayed to the primary user and the secondary user in the collaborative session.

10. The method of claim 9, further comprising:
receiving an item change request from the primary user to a secondary user in the collaborative session, wherein the change request comprises at least one of a request to add a new item, and a request to delete one or more of the assigned item.

11. The method of claim 10, wherein the storing further comprises:
receiving an item change request to modify one or more of the assigned items from the primary user to a secondary user in the collaborative session, wherein the primary user is restricted write access on the one or more items added by the secondary user to the shopping cart; and
displaying a notice at the mobile device of the secondary user in response to the received item change request.

12. The method of claim 8, further comprising:
receiving a selection of the secondary user displayed in the collaborative session and transmit an invitation to the selected secondary user, and
receiving invitation acceptance from the secondary user and add the secondary user to the collaborative session in the shopping application, wherein the collaborative session further comprises a group chatting user interface where the primary user and the secondary user collaborate via text or voice messaging.

13. The method of claim 8, further comprising:
sending location related information of the primary user and the secondary user in real-time, to the collaborative session executing in one or more servers for computing the current location of the primary user and the secondary user,
displaying the computed current location of the primary user and the secondary user in real-time in a store navigator user interface in the mobile device of the primary user; and
displaying current location of the secondary user along with the one or more items added by the secondary user in the store navigator user interface in the mobile device of the primary user.

14. The method of claim 13, further comprising:
displaying current locations of the one or more items added in the shopping cart in a first color, and current locations of the one or more items that are in the collaborative shopping list and yet to be added in the shopping cart in a second color in the store navigator user interface.

15. A computer system for in-store collaborative shopping, comprising:
a computer memory to store program code; and
a processor to execute the program code to:
retrieve an in-store shopping catalog comprising items to a collaborative session at a mobile device of a primary user;
add a secondary user to the collaborative session at a mobile device of the secondary user in response to a request of the primary user;
compile a collaborative shopping list based on items selected from the in-store shopping catalog by the primary user and a secondary user in the collaborative session;
in response to a selection from the primary user, assign one or more of the items from the compiled collaborative shopping list to the primary user and the secondary user in the collaborative session;
display a shopping cart to the primary user and the secondary user in the collaborative session in real-time, wherein one or more items are added by the primary user and the secondary user based on the assignment; and
initiate a self-checkout by at least one of the primary user or the secondary user to close the collaborative session and initiate a mobile payment process

16. The system of claim 15, wherein the processor further executes the program code to:
display the assigned one or more items to the primary user and the secondary user in the collaborative session in real-time;
receive scanned input of a barcode and a quantity associated with the one or more items assigned to the secondary user in the collaborative session; and
add the scanned input to the shopping cart displayed to the primary user and the secondary user in the collaborative session.

17. The system of claim 16, wherein the processor further executes the program code to:
receive an item change request from the primary user to a secondary user in the collaborative session, wherein the change request comprises at least one of a request to add a new item, and a request to delete one or more of the assigned item.

18. The system of claim 17, wherein the processor further executes the program code to:
receive an item change request to modify one or more of the assigned items from the primary user to a secondary user in the collaborative session, wherein the primary user is restricted write access on the one or more items added by the secondary user to the shopping cart; and
display a notice at the mobile device of the secondary user in response to the received item change request.

19. The system of claim 15, wherein the processor further executes the program code to:
receive a selection of the secondary user displayed in the collaborative session and transmit an invitation to the selected secondary user, and
receive invitation acceptance from the secondary user and add the secondary user to the collaborative session in the shopping application, wherein the collaborative session further comprises a group chatting user interface where the primary user and the secondary user collaborate via text or voice messaging.

20. The system of claim 15, wherein the processor further executes the program code to:
send location related information of the primary user and the secondary user in real-time, to the collaborative session executing in one or more servers for computing the current location of the primary user and the secondary user,
display the computed current location of the primary user and the secondary user in real-time in a store navigator user interface in the mobile device of the primary user; and
display current location of the secondary user along with the one or more items added by the secondary user in the store navigator user interface in the mobile device of the primary user.
